(19) United States
(12) Patent Application Publication
(10) Pub. No.: US 2023/0300135 A1
(43) Pub. Date: Sep. 21, 2023

(54) GENERATION OF MULTIPLE LIMITED-SCOPE ACCESS TOKENS

(71) Applicant: Citrix Systems, Inc., Fort Lauderdale, FL (US)

(72) Inventor: Subramanian Krishnan, Bangalore (IN)

(21) Appl. No.: 17/699,236

(22) Filed: Mar. 21, 2022

(51) Int. Cl. H04L 9/40; G06F 9/54

(52) U.S. Cl. CPC H04L 63/10; H04L 63/08; G06F 9/541

(57) ABSTRACT

In some disclosed embodiments, a first computing system may receive a message indicating that a resource owner has authorized a client application to make application programming interface (API) calls to both (A) a first access-restricted resource controlled by the resource owner, and (B) a second access-restricted resource controlled by the resource owner. In response to the message, the first computing system may generate both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource.

### BACKGROUND

Many software applications or websites may employ one or more application programming interfaces (APIs). An API of an application may allow outside communication with the application by systems running other applications. For example, another application or system may call the API of the application and request to obtain data, a service, or something else of value. The API may outline how other applications or systems may communicate with the API, such as the types and/or formats of calls or requests that can be made with the API. The API or a related server(s) may authenticate the other applications or systems or authorize calls or requests made by the other applications or systems.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a first computing system, a first message indicating that a resource owner has authorized a client application to make application programming interface (API) calls to both (A) a first access-restricted resource controlled by the resource owner, and (B) a second access-restricted resource controlled by the resource owner; in response to the first message, generating, by the first computing system, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource; and sending, from the first computing system to a second computing system, the first token and the second token to enable the second computing system to use the first token to make a first API call to the first API endpoint to access the first access-restricted resource, and to use the second token to make a second API call to the second API endpoint to access the second access-restricted resource.

In some disclosed embodiments, a first computing system comprises at least one first processor, and at least one first computer-readable medium encoded with instructions which, when executed by the at least one first processor, cause the first computing system to receive a first message indicating that a resource owner has authorized a client application to make application programming interface (API) calls to both (A) a first access-restricted resource controlled by the resource owner, and (B) a second access-restricted resource controlled by the resource owner, to generate, in response to the first message, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource, and to send, to a second computing system, the first token and the second token to enable the second computing system to use the first token to make a first API call to the first API endpoint to access the first access-restricted resource, and to use the second token to make a second API call to the second API endpoint to access the second access-restricted resource.

In some disclosed embodiments, at least one non-transitory computer-readable medium is encoded with instructions which, when executed by at least one processor of a first computing system, cause the first computing system to receive a first message indicating that a resource owner has authorized a client application to make application programming interface (API) calls to both (A) a first access-restricted resource controlled by the resource owner, and (B) a second access-restricted resource controlled by the resource owner, to generate, in response to the first message, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource, and to send, to a second computing system, the first token and the second token to enable the second computing system to use the first token to make a first API call to the first API endpoint to access the first access-restricted resource, and to use the second token to make a second API call to the second API endpoint to access the second access-restricted resource.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example user interface (UI) screen that an authorization server may generate for presentation to a resource owner to implement a single consent process;

FIG. 1B shows an example scenario in which a client app authenticates to an authorization service and obtains a multi-scope access token that can be used to access multiple different resources;

FIG. 1C shows an example system in which an API gateway can interact with an authorization service to exchange a master access token for a limited-scope token prior to making an API call to a service;

FIG. 1D shows an example of a main access token configured to include embedded claims for multiple, limited-scope access tokens;

FIG. 1E shows an example routine that may be performed by a first computing system (e.g., an authorization service) to generate and distribute multiple limited-scope access tokens to a second computing system (e.g., a client app, an API gateway, a token lookup service, etc.) in response to receipt of a single from a resource owner in accordance with some aspects of the present disclosure;

FIG. 2 is a diagram of a network environment in which some embodiments of the systems disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5 shows a first example configuration of the system shown in FIG. 1E;

FIG. 6 shows an example routine that may be performed by the authorization service shown in FIGS. 5, 9, and 11 in accordance with some aspects of the present disclosure;

FIG. 7A shows elements of an example sub token that may be generated by an authorization service in accordance with some aspects of the present disclosure;

FIG. 7B shows elements of an example main access token that may be generated by an authorization service in accordance with some aspects of the present disclosure;

FIG. 8 shows an example routine that may be performed by the client app shown in FIG. 5;

FIG. 9 shows a second example configuration of the system shown in FIG. 1E;

FIG. 10 shows an example routine that may be performed by the API gateway shown in FIG. 9;

FIG. 11 shows a third example configuration of the system shown in FIG. 1E; and

FIG. 12 shows an example routine that may be performed by the API gateway shown in FIG. 11.

### DETAILED DESCRIPTION

It is common for applications (or “apps,” for short) to integrate with multiple application programming interface (API) endpoints to obtain data, services, or something else of value from other applications. In some circumstances, such APIs may be “first party APIs,” which are provided by the same organization that is creating the app. In other circumstances, such APIs may additionally or alternatively be “third party APIs,” which are provided by an organization different than the one creating the app. Applications that interface with APIs of other resources are referred to herein as “client apps.”

As an example, the Citrix Workspace App, offered by Citrix Systems, Inc., of Fort Lauderdale, Fla., integrates with first party APIs, such as Files, Podio, Notifications, Workspace (core), Wrike, etc., which are all provided by different Citrix apps/services. At the same time, the Citrix Workspace App may also call third party APIs, such as SAP Concur, Workday, Salesforce, etc., through microapps implemented within it. In some sense, the Citrix Workspace App behaves as a “super-app” which provides a one stop solution for getting things done on other applications through the respective APIs.

To invoke the APIs of other apps/services, authentication and authorization mechanisms may be employed so that the client app can access resources on behalf of users in a secure and transparent way. Often, industry standards, such as the Open Authorization 2.0 (“OAuth 2”) protocol, are used to get the consent of the user on whose behalf a resource is to be accessed (referred to herein as the “resource owner”) prior to providing the client app with a token (e.g., a bearer token or an access token) that client app can use to access one or more resources/APIs on the user's behalf. The OAuth 2.0 protocol is described by “The OAuth 2.0 Authorization Framework,” Request for Comments (RFC) 6749, a product of the Internet Engineering Task Force (IETF), October 2012, the entire contents of which is incorporated herein by reference.

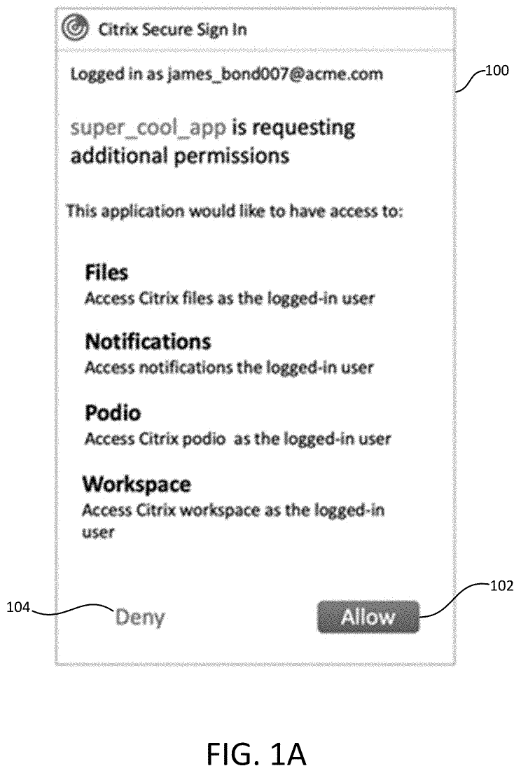

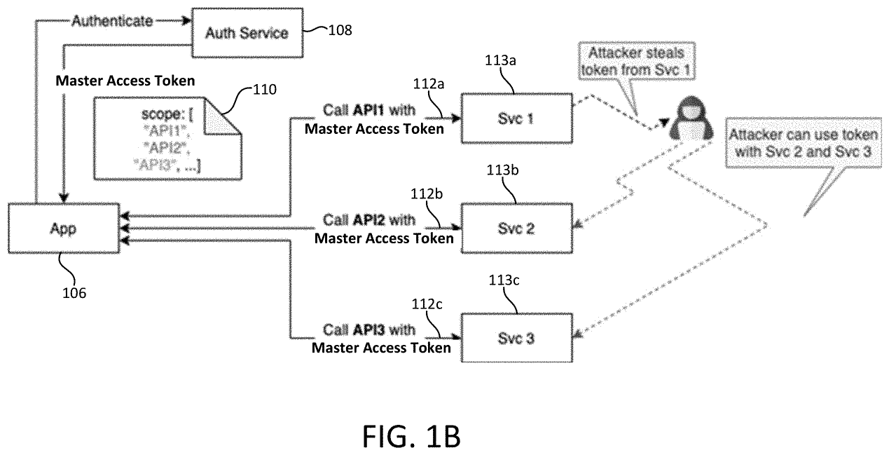

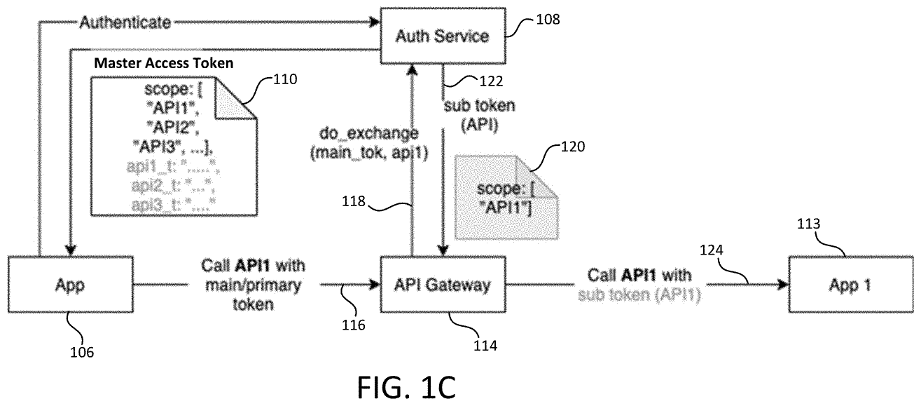

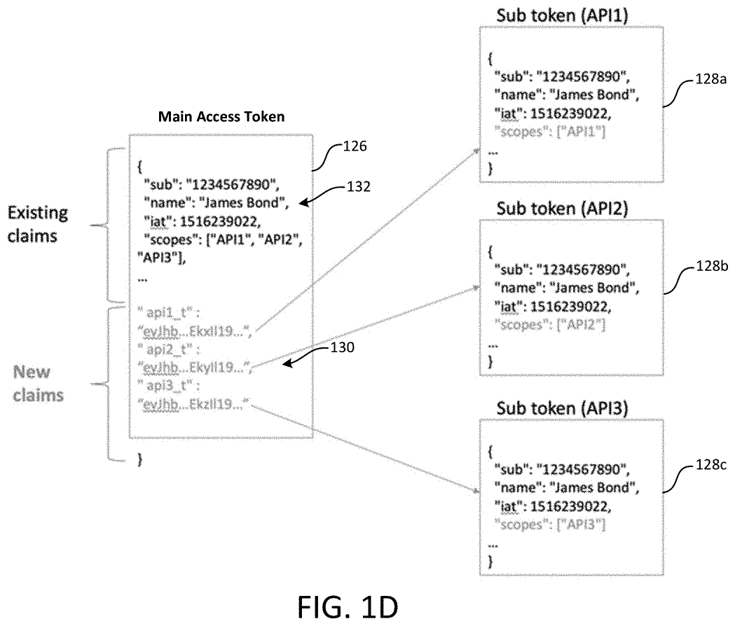

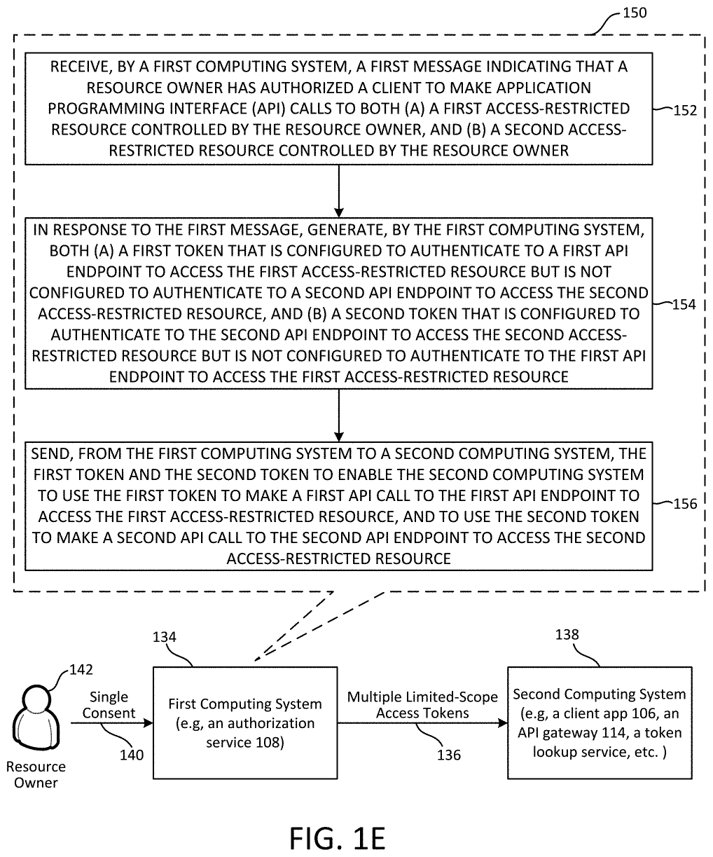

To simplify the experience of the resource owner, it is common for an authorization service (e.g., the “authorization server” of the OAuth 2.0 protocol) to implement a single consent process so that the resource owner can view all the scopes (permissions) requested for a set of different APIs, and to accept or reject all such scopes as a group. FIG. 1A shows an example user interface (UI) screen 100 that an authorization server may generate for presentation to a resource owner to implement such a single consent process. In the illustrated example, the UI screen 100 is requesting for the resource owner (i.e., an individual with the email address “james_bond007@acme.com”) to authorize a client app (i.e., an application named “super_cool_app”) to access APIs of four different resources (i.e., “Files,” “Notifications,” “Podio,” and “Workspace”). Via the UI screen 100, the resource owner may authorize the client app to access all four such resources by clicking on or otherwise selecting a single “allow” UI element 102, or may instead deny access to the indicated resources by clicking on or otherwise selecting a single “deny” UI element 104. The use of such a single consent process is typically done to prevent the resource owner from being burdened from having to click through multiple, separate consent screens for the various different APIs for which consent is being requested.

While the use of such a single consent process makes the client app implementation and experience optimal, as explained below, it creates new challenges. FIG. 1B illustrates an example scenario in which a client app 106 authenticates to an authorization service 108 (e.g., an OAuth 2.0 authorization server) and obtains a multi-scope access token 110 that can be used to access multiple different resources. As shown, in such a scenario, the master access token 110 issued by the authorization service 108 may contain all the scopes requested and approved by the resource owner (e.g., via a multi-resource consent process such as that described above in connection with FIG. 1A). Such an access token 110 essentially behaves as a “master” token because it can invoke any of the services for which it has a scope specified in claims. In the illustrated example, the master access token 110 has been configured to includes scopes that allow access to at least three different APIs (i.e., “API1,” “API2” and “API3”) belonging to respective services 113a, 113b, 113c (i.e., “Svc 1,” “Svc 2,” and “Svc 3”).

As indicated by arrows 112a, 112b, and 112c in FIG. 1B, the client app 106 may use the same master access token 110 to call any of the three APIs of the respective services 113. While this is the desired behavior from the client app perspective, the inventor has recognized and appreciated that the use of such a master access token can produce undesirable side effects and introduce potential security risks. Those side effects/security risks can be summarized as follows. When the client app 106 presents the master access token 110 to Svc 1 to access API1, access will be granted to API1 because API1 is included among the scopes listed within the master access token 110. However, the master access token 110 also has additional scopes (i.e., API2 and API3) which mean nothing to Svc 1. As such, as indicated on the right-hand side of FIG. 1B, in the event that the master access token 110 is compromised by an attack on Svc 1, the attacker would be able to call Svc 2 and Svc 3 as well because the compromised access token 110 includes scopes for API2 and API3, respectively. In an ideal and secure scenario, this sequence of events would not occur. That is, in the event that the master access token 110 gets compromised while accessing API1, it would be better if the attacker could not also gain access to API2 and API3 using the compromised token.

Before describing details of the novel systems and techniques disclosed herein for solving the above problem, various drawbacks of existing solutions to the problem will first be discussed. One known way to solve the problem is to introduce an intermediate component, e.g., an API Gateway 114, which does additional processing, as depicted in FIG. 1C. As shown in FIG. 1C, like the system described in connection with FIG. 1B, a master access token 110 including scopes for multiple resources may be generated and sent to the client app 106 in response to a single consent by the resource owner (e.g., via a multi-resource consent process such as that described above in connection with FIG. 1A). As indicated by an arrow 116 in FIG. 1C, to call any of the APIs within the authorized scopes, the client app 106 may send the master access token 110 to the API Gateway 114. Upon receipt of the master access token 110, the API Gateway 114 determines the API endpoint invoked by the client app 106. In the illustrated example, the client app 106 has invoked “API1” of an application named “App 1.” As indicated by an arrow 118 in FIG. 1C, the API gateway 114 then calls a token exchange API of the authorization service 108 to exchange the master access token 110 for another, substitute access token 120 which has only the scope(s) needed by API1. As indicated by an arrow 122 in FIG. 1C, the substitute access token 120 is returned to the API gateway 114. A new substitute access token 120 including the requisite scope(s) for a single service 113 is generated by the authorization service 108 each time the token exchange API is called (per the arrow 118). As indicated by an arrow 124 in FIG. 1C, the API gateway 114 then replaces the master access token 110 with the newly-generated substitute access token 120 received from the authorization service 108, and uses the substitute access token 120 to call the requested API, i.e., API1. Although not illustrated in FIG. 1C, another known approach with a similar result is for the authorization service 108 to send an opaque token, rather than a master access token 110, to the client app 106, and for the API gateway 114 to call a token exchange API of the authorization service 108 using the opaque token, rather than a master access token 110, to obtain a substitute access token 120. Unlike the master access token 110, an opaque token would not be recognized by any of the services 113 and would thus be useful to an attacker only if the attacker were able to successfully interact with the API gateway 114 to exchange the opaque token for a substitute access token 120 that one or more of the services 113 would recognize. In connection with such an opaque token exchange process, similar to the master access token exchange scenario described above, a new substitute access token 120 including the requisite scope(s) for a single service 113 is generated by the authorization service 108 each time the token exchange API is called using an opaque token.

The inventor has recognized and appreciated that, although the foregoing approaches can be used to solve the above-noted problem to at least some extent, there are a number of drawbacks to using them. A first drawback is that either such approach necessitates use of an intermediary component, such an API gateway, to exchange and swap tokens. A second drawback of these approaches is that they necessitate new APIs in the authorization service 108 to generate new single-service access tokens when a token exchange request, requesting an exchange for either a master access token or an opaque token, is received from the API gateway 114. Another drawback of these approaches is that every API call requires a call to the authorization service 108 to exchange tokens. This can be mitigated to some extent by caching previously-generated, single-service tokens but can't be avoided altogether. Further, caching generally imposes new security, cost, and scaling concerns. Further, in scenarios in which a master access token 110, as opposed to an opaque token, is provided to the client app 106, another drawback is that a need to trust the API gateway 114 is introduced because the API gateway 114 receives the master access token 110 from the client app 106.

Certain of the novel systems and methods described herein eliminate one or more, or in some cases all, of the foregoing drawbacks of existing solutions.

For purposes of reading the description of the various embodiments below, the following descriptions of the sections of the specification and their respective contents may be helpful:
Section A provides an introduction to example embodiments of a novel system for generating multiple limited-scope access tokens in accordance with some aspects of the present disclosure;
Section B describes a network environment which may be useful for practicing embodiments described herein;
Section C describes a computing system which may be useful for practicing embodiments described herein;
Section D describes embodiments of systems and methods for accessing computing resources using a cloud computing environment;
Section E provides a more detailed description of example embodiments of the system for generating multiple limited-scope access tokens introduced in Section A; and
Section F describes example implementations of methods, systems/devices, and computer-readable media in accordance with the present disclosure.

### A. Introduction to Illustrative Embodiments of a Novel System for Generating Multiple Limited-Scope Access Tokens

Offered are systems and techniques for generating multiple, different access tokens that can each be used to access only a single service (or a single subset of services) on behalf of a resource owner in response to a single consent of the resource owner. After such multiple, limited-scope access tokens have been generated, they can be made available for use in calling respective APIs on behalf of the resource owner in any of numerous ways. Several example implementations of systems capable of providing such functionality are described further below.

One of the novel features disclosed herein is that, after proper consent has been provided by the resource owner, the authorization service 108 (e.g., the “authorization server” of the OAuth 2.0 protocol) may generate multiple limited-scope access tokens, each specific to a single service/API 113 (or subset of services/APIs 113) and having only the scope(s) applicable to that service/API 113 (or subset of services/APIs 113). In some implementations, all such limited-scope access tokens may be packed/embedded into a “main” access token using custom claims so that those limited-scope access tokens can subsequently be unpacked and used individually by the client app 106 or an intermediate component (e.g., an API gateway 114) to access respective services 113. FIG. 1D illustrates an example of a main access token 126 that has been configured to include claims 130 for multiple, limited-scope access tokens 128a, 128b, 128c (referred to herein as “substitute tokens” or “sub tokens,” for short) embedded within it. As explained in more detail below, in some implementations, the main access token 126 may be provided to the client app 106 for use in making API calls to one or more of the services/APIs 113 for which the resource owner has provided consent. As further shown in FIG. 1D, in some implementations, the main access token 126 may additionally include claims 132 that allow it to be used as a “master” access token, similar to the master access token 110 described above in connection with FIGS. 1B and 1C. By including the claims 132 in the main access token 126, the main access token 126 may optionally be used as a master access token to access any of the multiple services/APIs 113 indicated by its scopes, such as when a client app 106 or intermediate component (e.g., an API gateway 114) is not configured to extract the sub tokens 128 from the main access token 126, as described in more detail below, thus allowing the main access token 126 to be backwards compatible with existing system, such as those described in connection with FIGS. 1B and 1C. In some implementations, the custom claims 130 for the sub tokens 128 may be optionally compressed before embedding them into the main access token 128 so that size of the main access token 128 does not become excessive. In such case, those custom claims 130 may be decompressed as a part of the sub token extraction process described below.

In some implementations, rather than having just two “levels” of access tokens as shown in FIG. 1D (i.e., a main access token 126 and a set of embedded sub tokens 128), additional “levels” of tokens may additionally be provided, with higher-level tokens containing broader scopes and embedded sub tokens containing finer scopes. For example, with reference to FIG. 1D, in some implementations, multiple additional sub tokens (not illustrated) may be embedded within one or more of the individual sub tokens 128a, 128b, 128c.

In some implementations, in addition to or in lieu of embedding the generated sub tokens 128 into a main access token 126 that is returned to the client app 106, the sub tokens 128 (which are generated in response to the single consent provided by the resource owner) may be stored in a storage medium associated with an intermediate component, such as an API gateway 114. In such implementations, the authorization service 108 may cause the sub tokens 128 to be stored (either individually or as a part of a main access token 126) in the storage medium in association with another token that is sent to the client app 106. In some implementations, the other token that is sent to the client app 106 may include a master access token, such as the master access token 110 described in connection with FIGS. 1B and 1C, and the generated sub tokens 128 may be stored in the storage medium (either individually or as a part of a main access token 126) in association with that master access token. In other implementations, the other token that is sent to the client app 106 may include an opaque token, such as described above in connection with FIG. 1C, and the generated sub tokens 128 may be stored (either individually or as a part of a main access token 126) in the storage medium in association with that opaque token.

As described in more detail below, in some such implementations, upon the intermediate component (e.g., the API gateway 114) receiving from the client app 106 a request that includes the other token the client app 106 received from the authorization service 108 (e.g., a master access token 110, an opaque token, or otherwise), a token lookup service included within or associated with the intermediate component (e.g., the API gateway 114) may use the other token to retrieve the pre-generated sub token 128 for the requested service 113 from the storage medium and use that retrieved sub token 128 to make an API call to the service 113. As noted above, in some such implementations, the sub tokens 128 may be embedded within a main access token 126 (as described above) and the main access token 126 may be stored in the storage medium associated with the intermediate component (e.g., the API gateway 114). In such implementations, the token lookup service and/or the intermediate component (e.g., the API gateway 114) may extract the needed sub token 128 from the main access token 126 in response to the intermediate component (e.g., the API gateway 114) receiving an API access request from the client app 106. In other implementations, the individual sub tokens 128 may be separately stored in the storage medium associated with the intermediate component (e.g., the API gateway 114). In such implementations, the token lookup service may simply retrieve the needed sub token 128 from the storage medium in response to the intermediate component (e.g., the API gateway 114) receiving an API access request from the client app 106, without having to extract the desired sub token 128 from a main access token 126.

Accordingly, in some implementations, the authorization service 108 may send the client app 106 a master access token 110 that is also sent to a token lookup service included within or associated with an intermediate component (e.g., an API gateway 114), and the sub tokens 128 may be stored in the storage medium (either separately or embedded within a main access token 126) in association with the master access token 110. In such implementations, the client app 106 may include the master access token 110 in an API call sent to the intermediate component (e.g., the API gateway 114), and the token lookup service and/or the intermediate component (e.g., the API gateway 114) may exchange the master access token 110 for an appropriate one of the pre-stored sub tokens 128 prior to the intermediate component (e.g., the API gateway 114) forwarding the API call to the requested service 113. If the sub tokens 128 are embedded within a main access token 126, the token lookup service and/or the intermediate component (e.g., the API gateway 114) may extract the desired sub token 128 from the main access token 126 upon receiving an API access request from the client app 106.

Similarly, in other implementations, the authorization service 108 may send the client app 106 an opaque token that is also sent to a token lookup service included within or associated with an intermediate component (e.g., the API gateway 114), and the sub tokens 128 may be stored in the storage medium (either separately or embedded within a main access token 126) in association with the opaque token. In such implementations, the client app 106 may include the opaque token in an API call sent to the intermediate component (e.g., the API gateway 114), and the token lookup service and/or the intermediate component (e.g., the API gateway 114) may exchange the opaque token for an appropriate one of the pre-stored sub tokens 128 prior to the intermediate component (e.g., the API gateway 114) forwarding the API call to the requested service 113. If the sub tokens 128 are embedded within a main access token 126, the token lookup service and/or the intermediate component (e.g., the API gateway 114) may extract the desired sub token 128 from the main access token 126 upon receiving an API access request from the client app 106.

FIG. 1E shows an example routine 150 that may be performed by a first computing system 134 (e.g., an authorization service 108) to generate and distribute multiple limited-scope access tokens (e.g., as indicated by an arrow 136) to a second computing system 138 (e.g., a client app 106, an API gateway 114, a token lookup service, etc.) in response to receipt of a single consent (e.g., as indicated by an arrow 140) from a resource owner 142 in accordance with some aspects of the present disclosure.

As shown, the routine 150 may begin at a step 152, at which the first computing system (e.g., an authorization service 108) may receive a first message (e.g., as indicated by the arrow 140) indicating that the resource owner 142 has authorized a client app 106 to make application programming interface (API) calls to both (A) a first access-restricted resource controlled by the resource owner, and (B) a second access-restricted resource controlled by the resource owner. For example, in some implementations, such a message may correspond to a communication received by an authorization service 108 (e.g., an OAuth 2.0 authorization server) in response to the resource owner 142 selecting a particular element on a UI screen for a single consent process, such as the “allow” UI element 102 of the UI screen 100 shown in FIG. 1A. The first and second access-restricted resources may, for example, correspond to respective services/APIs 113 to which API calls can be made using appropriate access tokens 110, 126, 128, as described above.

At a step 154 of the routine 150, in response to receipt of the first message, the first computing system 134 (e.g., an authorization service 108) may generate both (A) a first access token (e.g., the sub token 128a shown in FIG. 1D) that is configured to authenticate to a first API endpoint to access the first access-restricted resource (e.g., the service 113a shown in FIG. 1B) but is not configured to authenticate to a second API endpoint to access the second access-restricted resource (e.g., the service 113b shown in FIG. 1B), and (B) a second access token (e.g., the sub token 128b shown in FIG. 1D) that is configured to authenticate to the second API endpoint to access the second access-restricted resource (e.g., the service 113b shown in FIG. 1B) but is not configured to authenticate to the first API endpoint to access the first access-restricted resource (e.g., the service 113a shown in FIG. 1B). As noted above, in some implementations, the first computing system (e.g., an authorization service 108) may additionally embed the first token (e.g., the sub token 128a shown in FIG. 1D) and the second token (e.g., the sub token 128b shown in FIG. 1D) within a main access token, such as the main access token 126 shown in shown in FIG. 1D.

Finally, at a step 156 of the routine 150, the first computing system 134 (e.g., an authorization service 108) may send (e.g., as indicated by the arrow 136 in FIG. 1E) the first token (e.g., the sub token 128a shown in FIG. 1D) and the second token (e.g., the sub token 128b shown in FIG. 1D) to the second computing system 138 to enable the second computing system 138 to use the first token (e.g., the sub token 128a shown in FIG. 1D) to make a first API call to the first API endpoint to access the first access-restricted resource (e.g., the service 113a shown in FIG. 1B), and to use the second token (e.g., the sub token 128b shown in FIG. 1D) to make a second API call to the second API endpoint to access the second access-restricted resource (e.g., the service 113b shown in FIG. 1B).

In some implementations, the second computing system 138 may include a client app 106 that is configured to receive a main access token (e.g., the main access token 126 shown in shown in FIG. 1D) from the first computing system (e.g., an authorization service 108), and is further configured to extract the individual sub tokens 128 from the main access token 126, to allow the client app 106 to use appropriate sub tokens 128 to make API calls to respective services 113.

In other implementations, the second computing system 138 may include both a client app 106 to which the first computing system 134 (e.g., an authorization service 108) may send a main access token (e.g., the main access token 126 shown in FIG. 1D) as well as an intermediate component (e.g., an API gateway 114) that is configured to receive the main access token 126 from the client app 106, and is further configured to extract the individual sub tokens 128 from the main access token 126, to allow the intermediate component (e.g., an API gateway 114) to use appropriate sub tokens 128 to make API calls to respective services 113.

In still other implementations, the second computing system 138 may comprise a storage medium and a token lookup service that are included within or associated with an intermediate component (e.g., an API gateway 114), and first computing system 134 (e.g., an authorization service 108) may send the first and second access tokens it generated at the step 154 to the token lookup service for storage in the storage medium in association with another token (e.g., a master access token or an opaque token, as described above) that is also sent to the client app 106. As noted above, in some such implementations, the first and second access tokens may be embedded within a main access token (e.g., the main access token 126 shown in FIG. 1D) and that main access token may be stored in the storage medium in association with a copy of the other token (e.g., a master access token or an opaque token) that was sent to the client app 106. In other implementations, the first and second access tokens may be stored separately in the storage medium in association with a copy of the other token (e.g., a master access token or an opaque token) that was sent to the client app 106.

Additional details and example implementations of embodiments of the present disclosure are set forth below in Section E, following a description of example systems and network environments in which such embodiments may be deployed.

### B. Network Environment

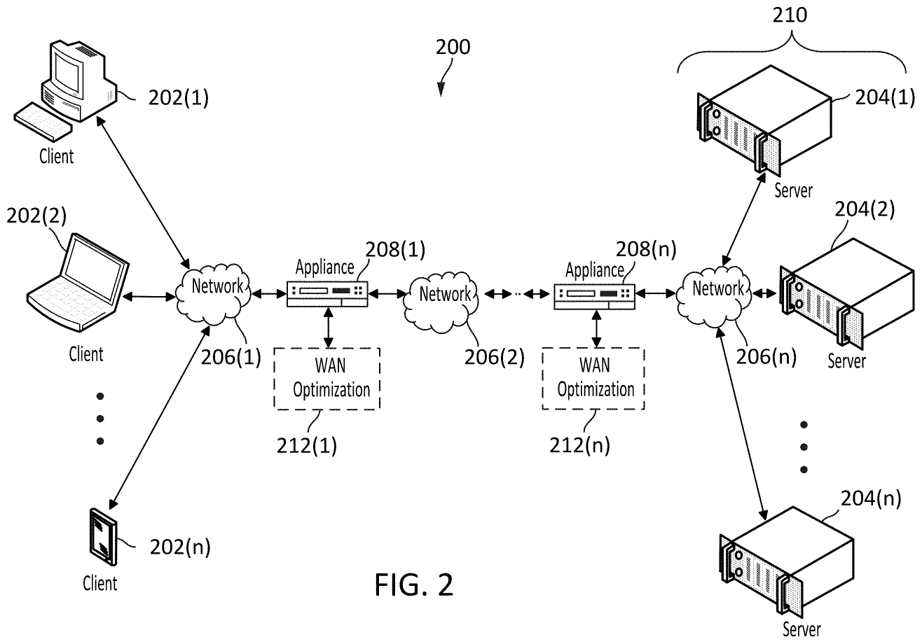

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

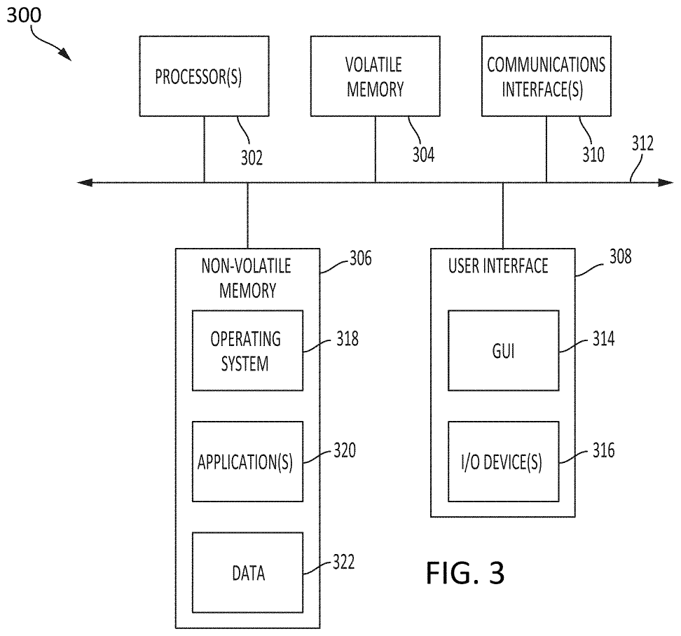

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

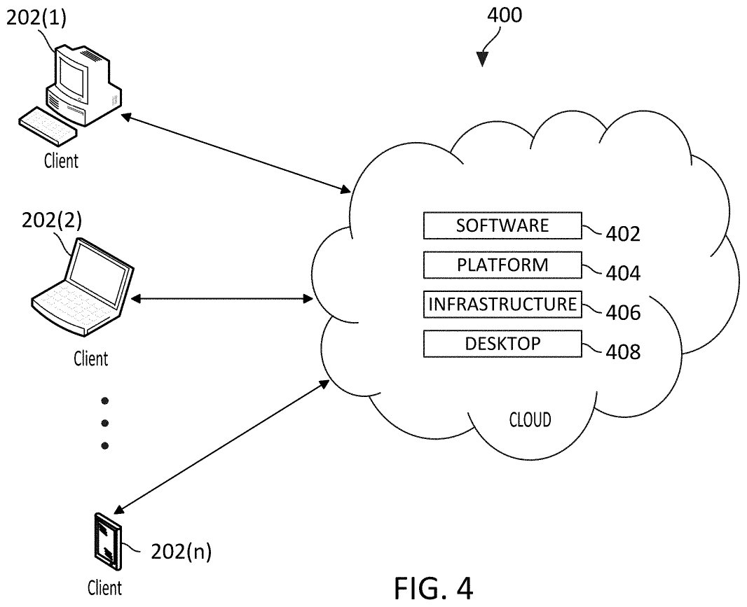

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Wash., Azure IaaS provided by Microsoft Corporation or Redmond, Wash., RACKSPACE CLOUD provided by Rackspace US, Inc., of San Antonio, Tex., Google Compute Engine provided by Google Inc. of Mountain View, Calif., and RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile® from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Detailed Description of Example Embodiments of the Novel System for Generating Multiple Limited-Scope Access Tokens Introduced in Section A

Section A introduced several example implementations of a system configured to generate multiple limited-scope access tokens (e.g., the sub tokens 128 described in connection with FIG. 1D) in response a single consent provided by a resource owner 142 (shown in FIG. 1E), as well as to allow the limited-scope access tokens that are so generated to be used to make API calls to individual services 113 on behalf of the resource owner 142.

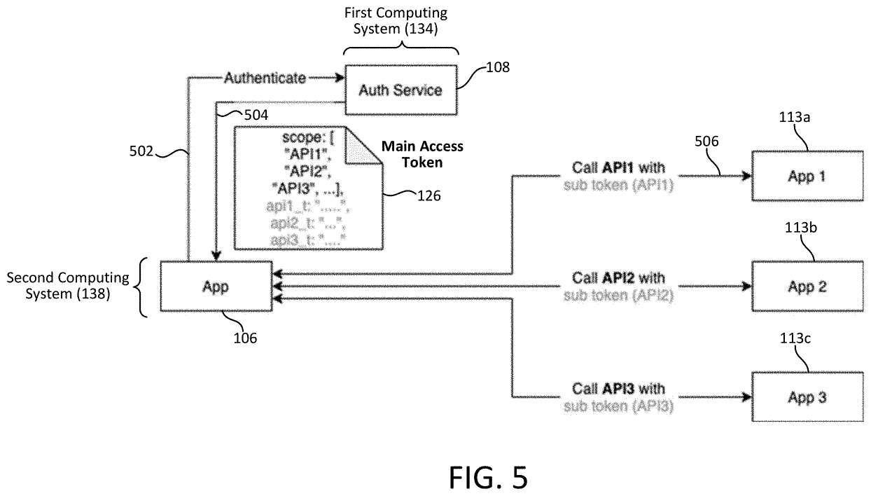

As noted near the end of Section A, in some implementations, the first computing system 134 (shown in FIG. 1E) may correspond to an authorization service 108 (e.g., an OAuth 2.0 authorization server) to which the resource owner 142 provides a single consent authorizing a client app 106 to access to a plurality of resources controlled by the resource owner 142 (e.g., via the single consent UI 100 shown in FIG. 1A), and the second computing system 138 (also shown in FIG. 1E) may correspond to the client app 106 for which such consent has been provided. FIG. 5 shows an example implementation of such a configuration.

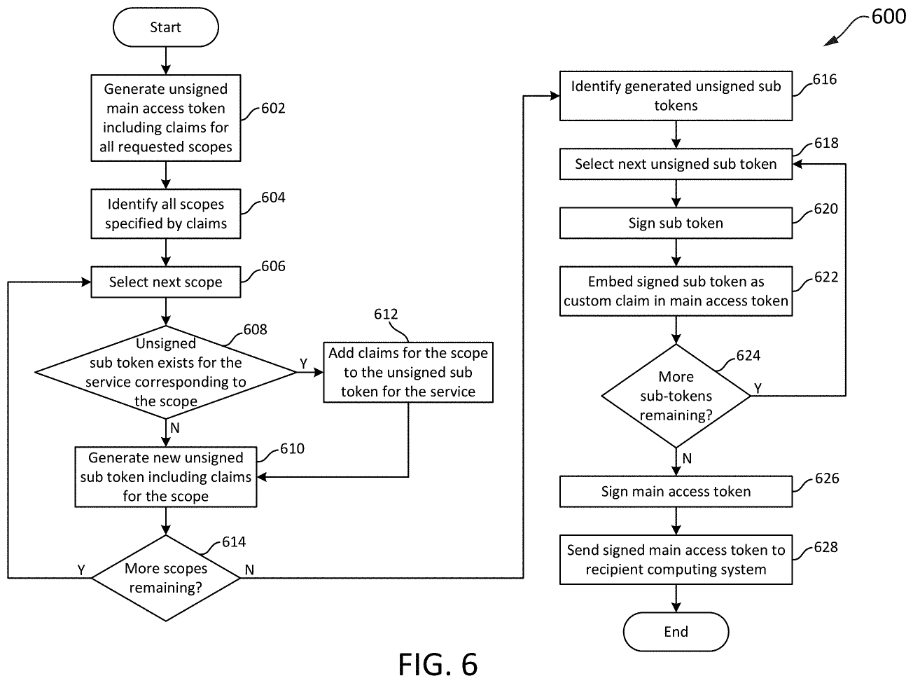

As shown in FIG. 5, after the client app 106 has authenticated to the authorization service 108 (e.g., as indicated by an arrow 502), the authorization service 108 may generate a main access token 126 (which may include multiple embedded sub tokens 128, as described above) and may return that main access token 126 to the client app 106 (e.g., as indicated by an arrow 504). An example routine 600 that may be employed by the authorization service 108 to generate the main access token 126 is described below in connection with FIG. 6. Although not illustrated in FIG. 5, in some implementations, the authorization service may be configured to send the main access token 126 to the client app 106 (per the arrow 504) only if the client app 106 first presents a suitable credential (referred to in the OAuth 2.0 specification as an “authorization grant”) to the authorization service 108 to prove that the resource owner 142 has consented to the client app 106 accessing the resources 113 corresponding to the sub tokens 128 (e.g., using a single consent process, as described above). As described in Section 1.3 of RFC 6749, incorporated by reference above, such an authorization grant may take on any of a number of forms and may be obtained in any of numerous ways.

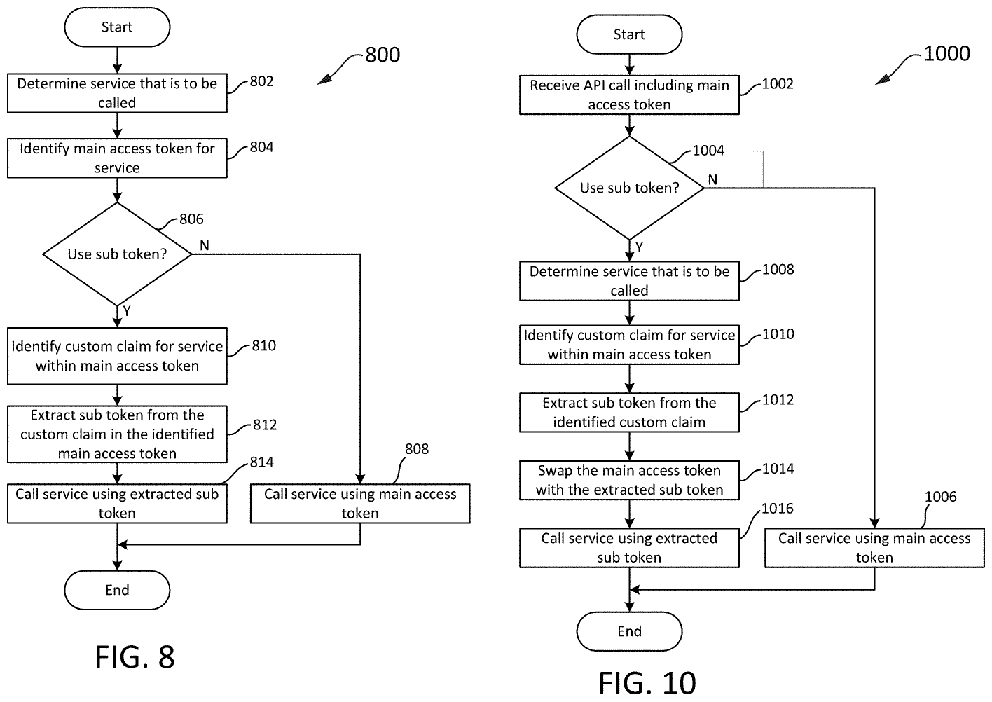

After the client app 106 receives the main access token 126 (per the arrow 504 in FIG. 5), the client app 106 may determine a service 113 it seeks to access, and may extract the sub token 128 corresponding to that service from the main access token 126. The client app 106 may then use the extracted sub token 128 to make an API call to the desired service 113. For example, as indicated by an arrow 506 in FIG. 5, the client app 106 may extract the sub token 128a (shown in FIG. 1D) from the main access token 126, and may use that sub token to make an API call to the service 113a. An example routine 800 that may be employed by the client app 106 to extract and use a sub token 128 in such fashion is described below in connection with FIG. 8.

In implementations in which the main access token 126 further includes claims 132 (shown in FIG. 1D) that allow the main access token 126 to be used as a master access token (e.g., such as the master access token 110 described in connection with FIGS. 1B and 1C), the client app 106 may instead use the main access token 126 to make API calls to one or more of the services 113, rather than extracting and using individual sub tokens 128. In such a case, the services 113 may ignore the custom claims 130 for the sub tokens, and may instead rely only on the claims 132 to allow access by the client app 106. As noted above, such a feature may allow client apps 106 that are not configured to extract sub tokens 128 from a main access token 126 to nonetheless use the main access token 126 to access the various services 113 for which access authorization consent was received from the resource owner 142, thus allowing the main access tokens 126 to be backwards compatible with existing client apps 106.

As noted above, FIG. 6 shows an example routine 600 that may be employed by the authorization service 108 to generate a main access token 126 that includes custom claims 130 corresponding to multiple different limited-scope sub tokens 128. As shown, the routine 600 may begin at a step 602, at which the authorization service 108 may generate an unsigned main access token 126 that includes claims 132 for all of the scopes requested by the client app 106. In some implementations, if the main access token 126 generated at the step 602 were signed in its current form, it would resemble the master access token 110 described above in connection with FIGS. 1B and 1C.

At a step 604 of the routine 600, the authorization service 108 may identify all of the scopes specified by the claims 132 of the unsigned main access token 126 generated at the step 602. Pursuant to a step 606 and decisions 608 and 614 of the routine 600, the authorization service 108 may iterate through all of the scopes identified at the step 604 and determine (at the decision 608) whether an unsigned sub token 128 has already been generated for the service 113 (e.g., an API endpoint) corresponding to the scope under consideration. Although the routine 600 illustrates the processing of the scopes identified at the step 604 as being performed sequentially, it should be appreciated that such processing may instead be performed wholly or partially in parallel.

When, at the decision 608, the authorization service 108 determines that an unsigned sub token 128 has not yet been generated for the service (e.g., an API endpoint) corresponding to the scope selected at the step 606, the routine 600 may proceed to a step 610, at which the authorization service 108 may generate a new unsigned sub token 128 that includes claims for the scope. When, on the other hand, the authorization service 108 determines (at the decision 608) that an unsigned sub token 128 has already been generated for the service (e.g., an API endpoint) corresponding to the scope, the authorization service 108 may instead add claims for the scope to the existing unsigned sub token 128 for that service.

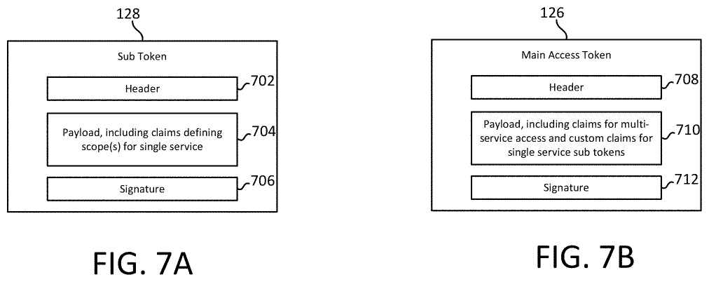

When, at the decision 614, the authorization service 108 determines that all of the scopes identified at the step 604 have been evaluated, the routine 600 may proceed to a step 616, at which the authorization service 108 may identify all of the unsigned sub tokens 128 that were generated at the step 610 and/or supplemented with additional claims per the step 612. Pursuant to a step 618 and a decision 624 of the routine 600, the authorization service 108 may iterate through all of the unsigned sub tokens 128 that were identified at the step 616 and, for each such sub token 128, may (per a step 620) sign the sub token 128, and (per a step 622) embed the signed sub token 128, as a custom claim 130, into the unsigned main access token 126 that was generated at the step 602. An example process for signing the respective sub tokens 128 is described below in connection with FIG. 7A. Although the routine 600 illustrates the processing of the sub tokens 128 identified at the step 616 as being performed sequentially, it should be appreciated that such processing may instead be performed wholly or partially in parallel.

When, at the decision 624, the authorization service 108 determines that all of the sub tokens 128 identified at the step 616 have been signed and embedded, as custom claims 130, into the unsigned main access token 126, the routine 600 may proceed to a step 626, at which the authorization service 108 may sign the fully-configured main access token 126. An example process for signing the main access token 126 is described below in connection with FIG. 7B.

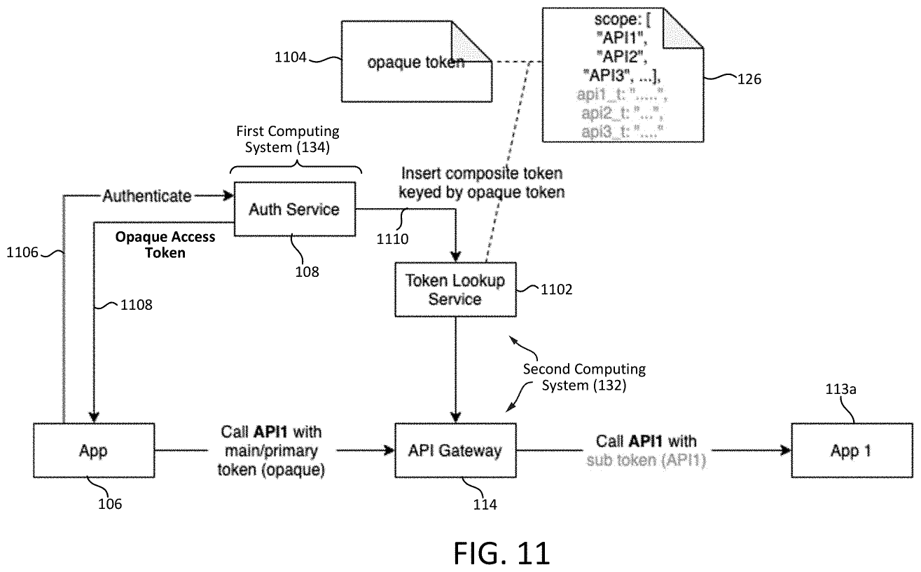

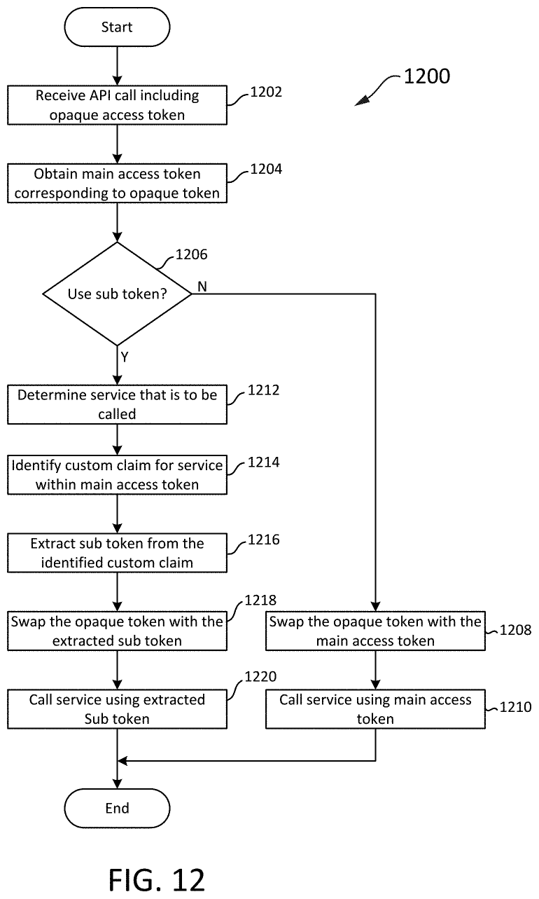

Finally, at a step 628 of the routine 600, the authorization service 108 may send the signed main access token 126 to a recipient computing system 138 (shown in FIG. 1E) for use in allowing the client app 106 to access the various resources 113 (e.g., API endpoints) for which the resource owner 142 provided consent. As noted above, in the implementation shown in FIG. 5, that recipient computing system 138 may include the client app 106. As explained in more detail below in connection with FIGS. 11 and 12, in other implementations, the recipient computing system 138 may additionally or alternatively include a token lookup service included within or associated with an intermediate component (e.g., an API gateway 114).

FIG. 7A shows elements of an example sub token 128 that has been signed per the step 620 of the routine 600. As illustrated, the sub token 128 may include a header 702, a payload 704, and a signature 706. The sub token 128 may, for example, be configured as a JSON Web Token (JWT). As illustrated, in some implementations, the payload 704 may include claims defining the scope(s) for a single service 113 (or subset of services 113). Further, in some implementations, the header 702 may specify a signing technique that the authorization service 108 used to generate the signature 706 based on the content of the header 702 and/or the payload 704. In some implementations, for example, the specified signing technique may involve (A) combining the base64url encoded header 702 and the base64url encoded payload 704, (B) hashing the combined base64url value with a hashing technique, e.g., SHA256, and (C) encrypting the determined hash using a private key.

In some implementations, a public key corresponding to the private key used to generate the signature 706 may be stored at or otherwise accessible to the service 113 (e.g., API endpoint) for which the sub token 128 is configured. As such, when the sub token 128 is received by that service 113, the service may validate the signature 706 using the public key and the specified signing technique, thus enabling the service 113 to confirm the sub token 128 has not been tampered with.

FIG. 7B shows elements of an example main access token 126 that has been signed per the step 626 of the routine 600. As illustrated, similar to the sub token 128 shown in FIG. 7A, the main access token 126 shown in FIG. 7B may include a header 708, a payload 710, and a signature 712. Like the sub token 128 shown in FIG. 7A, the main access token 126 shown in FIG. 7B, may, for example, be configured as a JSON Web Token (JWT). As illustrated, in some implementations, the payload 710 of the main access token 126 may include both (1) claims 132 defining the scope(s) for multiple services, thus allowing the main access token 126 to be used to access any of those services, and (2) custom claims 130 defining the respective embedded sub tokens 128. Further, in some implementations, the header 708 may specify a signing technique that the authorization service 108 used to generate the signature 712 based on the content of the header 708 and/or the payload 710. In some implementations, for example, the specified signing technique may involve (A) combining the base64url encoded header 708 and the base64url encoded payload 710, (B) hashing the combined base64url value with a hashing technique, e.g., SHA256, and (C) encrypting the determined hash using a private key.

Similar to the signature validation technique described above for the sub tokens 128, a public key corresponding to the private key used to generate the signature 712 for the main access token 126 may be stored at or otherwise accessible to the various services 113 (e.g., API endpoints) specified by the claims 132. As such, when the main access token 126 is received by any one of those services 113, that service 113 may validate the signature 712 using the public key and the specified signing technique, thus enabling the service 113 to confirm the main access token 126 has not been tampered with.

FIG. 8 shows an example routine 800 that may be employed by the client app 106 to extract an appropriate sub token 128 from the main access token 126 and to use that extracted sub token to call a service 113 (e.g., an API endpoint). As shown, the routine 800 may begin at a step 802, at which the client app 106 may determine a service 113 that is to be called. The step 802 may, for instance, correspond to the client app 106 determining a need to access to a remote service 113 to enable the performance of some business logic.

At a step 804 of the routine 800, the client app 106 may identify the main access token 126 that it previously received from the authorization service 108 (e.g., per the arrow 504 in FIG. 5) for the service 113 identified at the step 802. In some implementations, this may be done by evaluating the claims 132 of the various main access tokens 126 the client app 106 possesses, and identifying the main access token 126 that includes the appropriate scope(s) for the service identified at the step 802.

As illustrated in FIG. 8, in some implementations, the routine 800 may involve a decision 806, at which the client app 106 may determine whether a limited-scope sub token 128, rather than the main access token 126, is to be used to call the service 113 identified at the step 802. For client apps 106 that are configured to perform the sub-token extraction process described further below, the decision 806 may involve a determination as to whether such extraction functionality is currently enabled for the main access token 126 identified at the step 804. In such implementations, when (at the decision 806), the client app 106 determines that sub-token extraction functionality is not currently enabled for the identified main access token 126, the routine 800 may proceed to a step 808, at which the client app 106 may use the main access token 126 identified at the step 804, rather than a sub token 128, to call the service identified at the step 802. When, on the other hand, the client app 106 determines (at the decision 806) that sub-token extraction functionality is currently enabled for the identified main access token 126, the routine 800 may instead proceed to a step 810 at which the custom claim 130, within the main access token 126, for the service 113 identified at the step 802 may be identified. In some implementations, this may be accomplished by evaluating the custom claims 130 of the main access token 126 identified at the step 804, and identifying the custom claim 130 that includes the appropriate scope(s) for the service identified at the step 802.

At a step 812 of the routine 800, the client app 106 may extract the sub token 128 from the custom claim 130 identified at the step 810. In some implementations, such an extraction process may yield a sub token 128 having a configuration such as that shown in FIG. 7A, e.g., a JWT.

At a step 814 of the routine 800, the client app 106 may use the limited-scope sub token 128, e.g., a JWT, extracted from the main access token 126 per the step 812, to make an API call to service 113 (e.g., an API endpoint) identified at the step 802.

For client apps 106 that are not configured to extract a sub token 128 from the custom claims 130 of a main access token 126, the decision 806 may be omitted, and the routine 800 may instead simply proceed directly from the step 804 to the step 808.

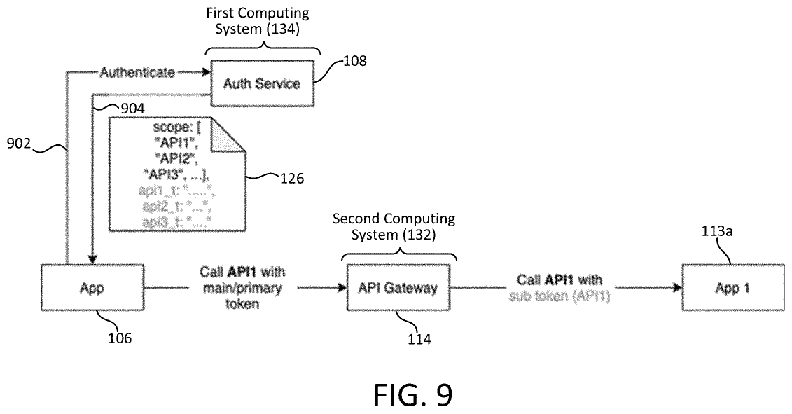

As additionally noted near the end of Section A, in some implementations, the first computing system 134 (shown in FIG. 1E) may correspond to an authorization service 108 (e.g., an OAuth 2.0 authorization server) to which the resource owner 142 provides a single consent authorizing a client app 106 to access to a plurality of resources controlled by the resource owner 142 (e.g., via the single consent UI 100 shown in FIG. 1A), and the second computing system 138 (also shown in FIG. 1E) may correspond to an intermediate component (e.g., an API gateway 114). In this configuration, the intermediate component (e.g., an API gateway 114), rather than the client app 106, may be responsible for extracting an appropriate sub token 128 from a main access token 126 for use in calling a desired service 113 (e.g., an API endpoint). FIG. 9 shows an example implementation of such a configuration.

As shown in FIG. 9, after the client app 106 has authenticated to the authorization service 108 (e.g., as indicated by an arrow 902), the authorization service 108 may generate a main access token 126 (which may include multiple embedded sub tokens 128, as described above) and may return that main access token 126 to the client app 106 (e.g., as indicated by an arrow 904). In some implementations, the example routine 600 described above in connection with FIG. 6 may be employed by the authorization service 108 to generate the main access token 126. Although not illustrated in FIG. 9, in some implementations, the authorization service may be configured to send the main access token 126 to the client app 106 (per the arrow 904) only if the client app 106 first presents a suitable credential (referred to in the OAuth 2.0 specification as an “authorization grant”) to the authorization service 108 to prove that the resource owner 142 has consented to the client app 106 accessing the resources 113 corresponding to the sub tokens 128 (e.g., using a single consent process, as described above). As described in Section 1.3 of RFC 6749, incorporated by reference above, such an authorization grant may take on any of a number of forms and may be obtained in any of numerous ways.

In the configuration shown in FIG. 9, rather than calling a service 113 (e.g., an API endpoint) directly, the client app 106 may make include the main access token 126 in an API call made to an API gateway 114 that serves as a proxy for the API endpoint of the service 113. The API gateway 114 may be configured to extract an appropriate sub token 128 from the received main access token 126, and may be further configured to include that extracted sub token 128 in the API call it forwards to the API endpoint of the service 113.

FIG. 10 shows an example routine 1000 that may be performed by the API gateway 114 shown in FIG. 9 to extract an appropriate sub token 128 from a received main access token 126, and to use that extracted sub token 128 to call a service 113 on behalf of the client app 106. As shown, the routine 1000 may begin at a step 1002, at which the API gateway 114 may receive an API call that includes a main access token 126 from a client app 106.

As illustrated in FIG. 10, in some implementations, the routine 1000 may involve a decision 1004, at which the API gateway 114 may determine whether a limited-scope sub token 128, rather than the main access token 126, is to be used to call a service 113. For API gateways 114 that are configured to perform the sub-token extraction process described further below, the decision 1004 may involve a determination as to whether such extraction functionality is currently enabled for the main access token 126 included in the received API call. In such implementations, when (at the decision 1004), the API gateway 114 determines that sub-token extraction functionality is not currently enabled for the received main access token 126, the routine 1000 may proceed to a step 1006, at which the API gateway 114 may use the received main access token 126, rather than a sub token 128, to call the service 113. When, on the other hand, the API gateway 114 determines (at the decision 1004) that sub-token extraction functionality is currently enabled for the received main access token 126, the routine 1000 may instead proceed to a step 1008, at which the API gateway 114 may determine the service 113 that is to be called. This determination may be made, for example, based on the content of the API call that was received from the client app 106.

At a step 1010 of the routine 1000, the API gateway 114 may identify the custom claim 130, within the main access token 126, for the service 113 identified at the step 1008. In some implementations, this may be accomplished by evaluating the custom claims 130 of the main access token 126 received from the client app 106, and identifying the custom claim 130 that includes the appropriate scope(s) for the service identified at the step 1008.

At a step 1012 of the routine 1000, the API gateway 114 may extract the sub token 128 from the custom claim 130 identified at the step 1010. In some implementations, such an extraction process may yield a sub token 128 having a configuration such as that shown in FIG. 7A, e.g., a JWT.

At a step 1014 of the routine 1000, the API gateway 114 may swap the main access token 126 received from the client app 106 with the sub token extracted per the step 1012.

At a step 1016 of the routine 1000, the API gateway 114 may make an API call to service 113 (e.g., an API endpoint) identified at the step 1008 using the limited-scope sub token 128, e.g., a JWT, that was swapped with the main access token 126 per the step 1014.

For API gateways 114 that are not configured to extract a sub token 128 from the custom claims 130 of a main access token 126, the decision 1004 may be omitted, and the routine 1000 may instead simply proceed directly from the step 1002 to the step 1006.

As further noted near the end of Section A, in some implementations, the first computing system 134 (shown in FIG. 1E) may correspond to an authorization service 108 (e.g., an OAuth 2.0 authorization server) to which the resource owner 142 provides a single consent authorizing a client app 106 to access to a plurality of resources controlled by the resource owner 142 (e.g., via the single consent UI 100 shown in FIG. 1A), and the second computing system 138 (also shown in FIG. 1E) may correspond to token lookup service that is associated with or included within an intermediate component (e.g., an API gateway 114). FIG. 11 shows an example of such a configuration, including a token lookup service 1102.

As shown in FIG. 11, similar to the configurations shown in FIGS. 5 and 9, after the client app 106 has authenticated to the authorization service 108 (e.g., as indicated by an arrow 1106), the authorization service 108 may generate a main access token 126 (which may include multiple embedded sub tokens 128, as described above). Rather than sending the main access token 126 to the client app 106, however, the authorization service 108 may generate an opaque token 1104 (described above) corresponding to the main access token 126, and may send that opaque token 1104 to the client app 106 (per an arrow 1108). As indicated by an arrow 1110 in FIG. 11, the authorization service 108 may also send both the main access token 126 and the corresponding opaque token 1104 to the token lookup service 1102, and the token lookup service 1102 may store the opaque token 1104 in association with the main access token 126 so that the opaque token 1104 may be used as a key to look up and retrieve the corresponding main access token 126 from a storage medium of the token lookup service 1102. In some implementations, the token lookup service 1102 may be included within or proximate (e.g., within a common network infrastructure) to the API gateway 114.

In some implementations, the example routine 600 described above in connection with FIG. 6 may be employed by the authorization service 108 to generate the main access token 126. Although not illustrated in FIG. 11, in some implementations, the authorization service 108 may be configured to send the opaque token 1104 to the client app 106 (per the arrow 1108) only if the client app 106 first presents a suitable credential (referred to in the OAuth 2.0 specification as an “authorization grant”) to the authorization service 108 to prove that the resource owner 142 has consented to the client app 106 accessing the resources 113 corresponding to the sub tokens 128 (e.g., using a single consent process, as described above). As described in Section 1.3 of RFC 6749, incorporated by reference above, such an authorization grant may take on any of a number of forms and may be obtained in any of numerous ways.

In the configuration shown in FIG. 11, similar to the configuration shown in FIG. 9, rather than calling a service 113 (e.g., an API endpoint) directly, the client app 106 may include the opaque token 1104 in an API call made to an API gateway 114 that serves as a proxy for the API endpoint of the service 113. In the configuration of FIG. 11, however, the API gateway 114 may be configured to swap the opaque token 1104 received from the client app 106 for an appropriate one of the sub tokens 128 prior to making an API call to the indicated service 113. In implementations in which the sub tokens 128 are include in a main access token 126, the token lookup service 1102 may first retrieve the main access token 126 corresponding to the received opaque token 1104, and may then extract the appropriate sub token 128 from the retrieved main access token 126.

FIG. 12 shows an example routine 1200 that may be performed by the API gateway 114 shown in FIG. 11 to use an opaque token 1104 received from a client app 106 to obtain an appropriate sub token 128, and to use that sub token 128 to call a service 113 on behalf of the client app 106. As shown, the routine 1200 may begin at a step 1202, at which the API gateway 114 may receive an API call that includes an opaque token 1104 from a client app 106.

At a step 1204 of the routine 1200, the API gateway 114 may obtain the main access token 126 that corresponds to the received opaque token 1104. In some implementations, for example, the API gateway 114 may provide the received opaque token 1104 to the token lookup service 1102, and the token lookup service 1102 may retrieve and return the main access token 126 keyed by the opaque token 1104 to the API gateway 114.

As illustrated in FIG. 12, in some implementations, the routine 1200 may involve a decision 1206, at which the API gateway 114 may determine whether a limited-scope sub token 128, rather than the main access token 126, is to be used to call a service 113. For API gateways 114 that are configured to perform the sub-token extraction process described further below, the decision 1206 may involve a determination as to whether such extraction functionality is currently enabled for the main access token 126 obtained from the token lookup service 1102. In such implementations, when (at the decision 1206), the API gateway 114 determines that sub-token extraction functionality is not currently enabled for the retrieved main access token 126, the routine 1200 may proceed to steps 1208 and 1210, at which the API gateway 114 may swap the main access token 126 for the opaque token 1104 in the received API call (per the step 1208), and use the main access token 126, rather than a sub token 128, to call the service 113 (per step 1210). When, on the other hand, the API gateway 114 determines (at the decision 1206) that sub-token extraction functionality is currently enabled for the retrieved main access token 126, the routine 1200 may instead proceed to a step 1212, at which the API gateway 114 may determine the service 113 that is to be called. This determination may be made, for example, based on the content of the API call received from the client app 106.

At a step 1214 of the routine 1200, the API gateway 114 may identify the custom claim 130, within the main access token 126, for the service 113 identified at the step 1212. In some implementations, this may be accomplished by evaluating the custom claims 130 of the main access token 126 received from the token lookup service 1102, and identifying the custom claim 130 that includes the appropriate scope(s) for the service identified at the step 1212.

At a step 1216 of the routine 1200, the API gateway 114 may extract the sub token 128 from the custom claim 130 identified at the step 1214. In some implementations, such an extraction process may yield a sub token 128 having a configuration such as that shown in FIG. 7A, e.g., a JWT.

At a step 1218 of the routine 1200, the API gateway 114 may swap the opaque token 1104 received from the client app 106 with the sub token 128 extracted per the step 1216.

At a step 1220 of the routine 1200, the API gateway 114 may make an API call to service 113 (e.g., an API endpoint) identified at the step 1212 using the limited-scope sub token 128, e.g., a JWT, that was swapped with the opaque token 1104 per the step 1218.

For API gateways 114 that are not configured to extract a sub token 128 from the custom claims 130 of a main access token 126, the decision 1206 may be omitted, and the routine 1200 may instead simply proceed directly from the step 1204 to the step 1208.

F. Example Implementations of Methods, Systems, and Computer-Readable Media in Accordance with the Present Disclosure

The following paragraphs (M1) through (M12) describe examples of methods that may be implemented in accordance with the present disclosure.

(M1) A method may involve receiving, by a first computing system, a first message indicating that a resource owner has authorized a client application to make application programming interface (API) calls to both (A) a first access-restricted resource controlled by the resource owner, and (B) a second access-restricted resource controlled by the resource owner; in response to the first message, generating, by the first computing system, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource; and sending, from the first computing system to a second computing system, the first token and the second token to enable the second computing system to use the first token to make a first API call to the first API endpoint to access the first access-restricted resource, and to use the second token to make a second API call to the second API endpoint to access the second access-restricted resource.

(M2) A method may be performed as described in paragraph (M1), and may further involve embedding, by the first computing system, the first token and the second token into a main token; and sending, from the first computing system to the second computing system, the main token.

(M3) A method may be performed as described in paragraph (M2), and may further involve receiving, by the second computing system, the main token; extracting, by the second computing system, first data representing the first token from the main token to obtain a copy of the first token; and using, by the second computing system, the copy of the first token to make the first API call to the first API endpoint.

(M4) A method may be performed as described in paragraph (M2) or paragraph (M3), and may further involve configuring, by the first computing system, the main token to further enable the second computing system to use the main token to both (A) to authenticate to the first API endpoint to access the first access-restricted resource, and (B) to authenticate to the second API endpoint to access the second access-restricted resource.

(M5) A method may be performed as described in paragraph (M4), and may further involve generating the first token comprises adding a first signature to the first token that is based at least in part on content of the first token; generating the second token comprises adding a second signature to the second token that is based at least in part on content of the second token; and configuring the main token comprises adding a third signature to the main token that is based at least in part on the first signature and the second signature.

(M6) A method may be performed as described in paragraph (M2), wherein the second computing system may comprise the client application; and sending the main token to the second computing system may further involve sending the main token to the client application.

(M7) A method may be performed as described in paragraph (M6), and may further involve receiving, by the client application, the main token; extracting, by the client application, first data representing the first token from the main token to obtain a copy of the first token that is used to make the first API call; and using, by the client application, the copy of the first token to make the first API call to the first API endpoint.

(M8) A method may be performed as described in paragraph (M6), wherein the second computing system may further comprise an API gateway, and the method may further involve receiving, by the API gateway and from the client application, the main token; extracting, by the API gateway, first data representing the first token from the main token to obtain a copy of the first token that is used to make the first API call; and using, by the API gateway, the copy of the first token to make the first API call to the first API endpoint.

(M9) A method may be performed as described in paragraph (M1), wherein the second computing system may comprise an API gateway, a token lookup service, and a storage medium accessible to the token lookup service, and the method may further involve storing, in the storage medium, first data representing the first token and second data representing the second token; receiving, by the API gateway and from the client application, a request to make the first API call to the first API endpoint; in response to the request, retrieving, by the token lookup service, the first data from the storage medium to obtain a copy of the first token that is used to make the first API call to the first API endpoint; and using, by the API gateway, the copy of the first token to make the first API call to the first API endpoint.

(M10) A method may be performed as described in paragraph (M9), wherein storing the first data and the second data in the storage medium may further involve embedding the first data representing the first token and the second data representing the second token into a main token, and storing a copy of the main token in the storage medium; retrieving the first data from the storage medium may further involve retrieving the copy of the main token from the storage medium on a first occasion, and extracting the first data representing the first token from the copy of the main token of the first occasion; and retrieving the second data from the storage medium may further involve retrieving the copy of the main token from the storage medium on a second occasion, and extracting the first token from the main token on the second occasion.

(M11) A method may be performed as described in paragraph (M10), wherein the first computing system may further comprise an authorization service configured to generate the main token, and the method may further involve sending, from the authorization service to the client application, an opaque token corresponding to the main token; determining, by the API gateway and based at least in part on receipt of the opaque token from the client application on the first occasion, that the client application has requested that the first API call be made to the first access-restricted resource; and determining, by the API gateway and based at least in part on receipt of the opaque token from the client application on the second occasion, that the client application has requested that the second API call be made to the second access-restricted resource.

(M12) A method may be performed as described in paragraph (M10), wherein the first computing system may further comprise an authorization service configured to generate the first token and the second token, and the method may further involve sending, from the authorization service to the client application, an opaque token corresponding to each of the first token and the second token; determining, by the API gateway and based at least in part on receipt of the opaque token from the client application on a first occasion, that the client application has requested that the first API call be made to the first access-restricted resource; and determining, by the API gateway and based at least in part on receipt of the opaque token from the client application on a second occasion, that the client application has requested that the second API call be made to the second access-restricted resource.

The following paragraphs (S1) through (S12) describe examples of systems and devices that may be implemented in accordance with the present disclosure.

(S1) A system may comprise a first computing system including at least one first processor and at least one first computer-readable medium encoded with instructions which, when executed by the at least one first processor, cause the first computing system to receive a first message indicating that a resource owner has authorized a client application to make application programming interface (API) calls to both (A) a first access-restricted resource controlled by the resource owner, and (B) a second access-restricted resource controlled by the resource owner, to generate, in response to the first message, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource, and to send, to a second computing system, the first token and the second token to enable the second computing system to use the first token to make a first API call to the first API endpoint to access the first access-restricted resource, and to use the second token to make a second API call to the second API endpoint to access the second access-restricted resource.

(S2) A system may be configured as described in paragraph (S1), and the at least one first computer-readable medium may be further encoded with additional instructions which, when executed by the at least one first processor, further cause the first computing system to embed the first token and the second token into a main token, and to send, to the second computing system, the main token.

(S3) A system may be configured as described in paragraph (S2), and may further include at least one second processor, and at least one second computer-readable medium encoded with instructions which, when executed by the at least one second processor, cause the second computing system to receive the main token, to extract first data representing the first token from the main token to obtain a copy of the first token, and to use the copy of the first token to make the first API call to the first API endpoint.

(S4) A system may be configured as described in paragraph (S2) or paragraph (S3), and the at least one first computer-readable medium may be further encoded with additional instructions which, when executed by the at least one first processor, further cause the first computing system to configure the main token to further enable the second computing system to use the main token to both (A) to authenticate to the first API endpoint to access the first access-restricted resource, and (B) to authenticate to the second API endpoint to access the second access-restricted resource.

(S5) A system may be configured as described in paragraph (S4), and the at least one first computer-readable medium may be further encoded with additional instructions which, when executed by the at least one first processor, further cause the first computing system add a first signature to the first token that is based at least in part on content of the first token, to add a second signature to the second token that is based at least in part on content of the second token, and to add a third signature to the main token that is based at least in part on the first signature and the second signature.

(S6) A system may be configured as described in paragraph (S2), wherein the second computing system may comprise the client application; and the at least one first computer-readable medium may be further encoded with additional instructions which, when executed by the at least one first processor, further cause the first computing system to send the main token to the client application.

(S7) A system may be configured as described in paragraph (S6), wherein the client application may be configured to receive the main token, to extract first data representing the first token from the main token to obtain a copy of the first token that is used to make the first API call, and to use the copy of the first token to make the first API call to the first API endpoint.

(S8) A system may be configured as described in paragraph (S6), wherein the second computing system may further include an API gateway, and the system may further include at least one second processor, and at least one second computer-readable medium encoded with instructions which, when executed by the at least one second processor, cause the second computing system to receive, by the API gateway and from the client application, the main token, to extract, by the API gateway, first data representing the first token from the main token to obtain a copy of the first token that is used to make the first API call, and to use, by the API gateway, the copy of the first token to make the first API call to the first API endpoint.

(S9) A system may be configured as described in paragraph (S1), wherein the second computing system may comprise an API gateway, a token lookup service, and a storage medium accessible to the token lookup service, and the system may further include at least one second processor, and at least one second computer-readable medium encoded with instructions which, when executed by the at least one second processor, cause the second computing system to store, in the storage medium, first data representing the first token and second data representing the second token, to receive, by the API gateway and from the client application, a request to make the first API call to the first API endpoint, to retrieve, by the token lookup service and in response to the request, the first data from the storage medium to obtain a copy of the first token that is used to make the first API call to the first API endpoint, and to use, by the API gateway, the copy of the first token to make the first API call to the first API endpoint.

(S10) A system may be configured as described in paragraph (S9), and the at least one second computer-readable medium may be further encoded with additional instructions which, when executed by the at least one second processor, further cause the second computing system to store the first data and the second data in the storage medium at least in part by embedding the first data representing the first token and the second data representing the second token into a main token, and storing a copy of the main token in the storage medium, to retrieve the first data from the storage medium at least in part by retrieving the copy of the main token from the storage medium on a first occasion, and extracting the first data representing the first token from the copy of the main token of the first occasion, and to retrieve the second data from the storage medium at least in part by retrieving the copy of the main token from the storage medium on a second occasion, and extracting the first token from the main token on the second occasion.

(S11) A system may be configured as described in paragraph (S10), wherein the first computing system may further comprise an authorization service configured to generate the main token, the at least one first computer-readable medium may be further encoded with additional instructions which, when executed by the at least one first processor, further cause the first computing system to send, from the authorization service to the client application, an opaque token corresponding to the main token, and the at least one second computer-readable medium may be further encoded with additional instructions which, when executed by the at least one second processor, further cause the second computing system to determine, by the API gateway and based at least in part on receipt of the opaque token from the client application on the first occasion, that the client application has requested that the first API call be made to the first access-restricted resource, and to determine, by the API gateway and based at least in part on receipt of the opaque token from the client application on the second occasion, that the client application has requested that the second API call be made to the second access-restricted resource.

(S12) A system may be configured as described in paragraph (S10), wherein the first computing system may further comprise an authorization service configured to generate the first token and the second token, the at least one first computer-readable medium may be further encoded with additional instructions which, when executed by the at least one first processor, further cause the first computing system to send, from the authorization service to the client application, an opaque token corresponding to each of the first token and the second token, and the at least one second computer-readable medium may be further encoded with additional instructions which, when executed by the at least one second processor, further cause the second computing system to determine, by the API gateway and based at least in part on receipt of the opaque token from the client application on a first occasion, that the client application has requested that the first API call be made to the first access-restricted resource, and to determine, by the API gateway and based at least in part on receipt of the opaque token from the client application on a second occasion, that the client application has requested that the second API call be made to the second access-restricted resource.

The following paragraphs (CRM1) through (CRM12) describe examples of computer-readable media that may be implemented in accordance with the present disclosure.

(CRM1) At least one non-transitory computer readable medium may include at least one first computer-readable medium that may be encoded with instructions which, when executed by at least one first processor of a first computing system, cause the first computing system to receive a first message indicating that a resource owner has authorized a client application to make application programming interface (API) calls to both (A) a first access-restricted resource controlled by the resource owner, and (B) a second access-restricted resource controlled by the resource owner, to generate, in response to the first message, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource, and to send, to a second computing system, the first token and the second token to enable the second computing system to use the first token to make a first API call to the first API endpoint to access the first access-restricted resource, and to use the second token to make a second API call to the second API endpoint to access the second access-restricted resource.

(CRM2) At least one non-transitory computer readable medium may be configured as described in paragraph (CRM1), and the at least one first computer-readable medium may be further encoded with additional instructions which, when executed by the at least one first processor, further cause the first computing system to embed the first token and the second token into a main token, and to send, to the second computing system, the main token.

(CRM3) At least one non-transitory computer readable medium may be configured as described in paragraph (CRM2), and may further include at least one second computer-readable medium encoded with instructions which, when executed by at least one second processor of the second computing system, cause the second computing system to receive the main token, to extract first data representing the first token from the main token to obtain a copy of the first token, and to use the copy of the first token to make the first API call to the first API endpoint.

(CRM4) At least one non-transitory computer readable medium may be configured as described in paragraph (CRM2) or paragraph (CRM3), and the at least one first computer-readable medium may be further encoded with additional instructions which, when executed by the at least one first processor, further cause the first computing system to configure the main token to further enable the second computing system to use the main token to both (A) to authenticate to the first API endpoint to access the first access-restricted resource, and (B) to authenticate to the second API endpoint to access the second access-restricted resource.

(CRM5) At least one non-transitory computer readable medium may be configured as described in paragraph (CRM4), and the at least one first computer-readable medium may be further encoded with additional instructions which, when executed by the at least one first processor, further cause the first computing system add a first signature to the first token that is based at least in part on content of the first token, to add a second signature to the second token that is based at least in part on content of the second token, and to add a third signature to the main token that is based at least in part on the first signature and the second signature.

(CRM6) At least one non-transitory computer readable medium may be configured as described in paragraph (CRM2), wherein the at least one first computer-readable medium may be further encoded with additional instructions which, when executed by the at least one first processor, further cause the first computing system to send the main token to the client application.

(CRM7) At least one non-transitory computer readable medium may be configured as described in paragraph (CRM6), and may further include at least one second computer-readable medium encoded with instructions which, when executed by at least one second processor of the second computing system, cause the client application to receive the main token, to extract first data representing the first token from the main token to obtain a copy of the first token that is used to make the first API call, and to use the copy of the first token to make the first API call to the first API endpoint.

(CRM8) At least one non-transitory computer readable medium may be configured as described in paragraph (CRM6), and may further include at least one second computer-readable medium encoded with instructions which, when executed by at least one second processor of the second computing system, cause the second computing system to receive, by an API gateway and from the client application, the main token, to extract, by the API gateway, first data representing the first token from the main token to obtain a copy of the first token that is used to make the first API call, and to use, by the API gateway, the copy of the first token to make the first API call to the first API endpoint.

(CRM9) At least one non-transitory computer readable medium may be configured as described in paragraph (CRM1), and may further include at least one second computer-readable medium encoded with instructions which, when executed by at least one second processor of the second computing system, cause the second computing system to store, in a storage medium, first data representing the first token and second data representing the second token, to receive, by an API gateway and from the client application, a request to make the first API call to the first API endpoint, to retrieve, by a token lookup service and in response to the request, the first data from the storage medium to obtain a copy of the first token that is used to make the first API call to the first API endpoint, and to use, by the API gateway, the copy of the first token to make the first API call to the first API endpoint.

(CRM10) At least one non-transitory computer readable medium may be configured as described in paragraph (CRM9), and the at least one second computer-readable medium may be further encoded with additional instructions which, when executed by the at least one second processor, further cause the second computing system to store the first data and the second data in the storage medium at least in part by embedding the first data representing the first token and the second data representing the second token into a main token, and storing a copy of the main token in the storage medium, to retrieve the first data from the storage medium at least in part by retrieving the copy of the main token from the storage medium on a first occasion, and extracting the first data representing the first token from the copy of the main token of the first occasion, and to retrieve the second data from the storage medium at least in part by retrieving the copy of the main token from the storage medium on a second occasion, and extracting the first token from the main token on the second occasion.

(CRM11) At least one non-transitory computer readable medium may be configured as described in paragraph (CRM10), wherein at least one first computer-readable medium may be further encoded with additional instructions which, when executed by the at least one first processor, further cause the first computing system to send, from an authorization service to the client application, an opaque token corresponding to the main token, and the at least one second computer-readable medium may be further encoded with additional instructions which, when executed by the at least one second processor, further cause the second computing system to determine, by the API gateway and based at least in part on receipt of the opaque token from the client application on the first occasion, that the client application has requested that the first API call be made to the first access-restricted resource, and to determine, by the API gateway and based at least in part on receipt of the opaque token from the client application on the second occasion, that the client application has requested that the second API call be made to the second access-restricted resource.

(CRM12) At least one non-transitory computer readable medium may be configured as described in paragraph (CRM10), wherein the at least one first computer-readable medium may be further encoded with additional instructions which, when executed by the at least one first processor, further cause the first computing system to send, from an authorization service to the client application, an opaque token corresponding to each of the first token and the second token, and the at least one second computer-readable medium may be further encoded with additional instructions which, when executed by the at least one second processor, further cause the second computing system to determine, by the API gateway and based at least in part on receipt of the opaque token from the client application on a first occasion, that the client application has requested that the first API call be made to the first access-restricted resource, and to determine, by the API gateway and based at least in part on receipt of the opaque token from the client application on a second occasion, that the client application has requested that the second API call be made to the second access-restricted resource.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a first computing system, a first message indicating that a resource owner has authorized a client application to make application programming interface (API) calls to both (A) a first access-restricted resource controlled by the resource owner, and (B) a second access-restricted resource controlled by the resource owner;
in response to the first message, generating, by the first computing system, both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource; and
sending, from the first computing system to a second computing system, the first token and the second token to enable the second computing system to use the first token to make a first API call to the first API endpoint to access the first access-restricted resource, and to use the second token to make a second API call to the second API endpoint to access the second access-restricted resource.

2. The method of claim 1, further comprising:
embedding, by the first computing system, the first token and the second token into a main token; and
sending, from the first computing system to the second computing system, the main token.

3. The method of claim 2, further comprising:
receiving, by the second computing system, the main token;
extracting, by the second computing system, first data representing the first token from the main token to obtain a copy of the first token; and
using, by the second computing system, the copy of the first token to make the first API call to the first API endpoint.

4. The method of claim 3, further comprising:
configuring, by the first computing system, the main token to further enable the second computing system to use the main token to both (A) to authenticate to the first API endpoint to access the first access-restricted resource, and (B) to authenticate to the second API endpoint to access the second access-restricted resource.

5. The method of claim 4, wherein:
generating the first token comprises adding a first signature to the first token that is based at least in part on content of the first token;
generating the second token comprises adding a second signature to the second token that is based at least in part on content of the second token; and
configuring the main token comprises adding a third signature to the main token that is based at least in part on the first signature and the second signature.

6. The method of claim 2, wherein:
the second computing system comprises the client application; and
sending the main token to the second computing system comprises sending the main token to the client application.

7. The method of claim 6, further comprising:
receiving, by the client application, the main token;
extracting, by the client application, first data representing the first token from the main token to obtain a copy of the first token that is used to make the first API call; and
using, by the client application, the copy of the first token to make the first API call to the first API endpoint.

8. The method of claim 6, wherein the second computing system further comprises an API gateway, and the method further comprises:
receiving, by the API gateway and from the client application, the main token;
extracting, by the API gateway, first data representing the first token from the main token to obtain a copy of the first token that is used to make the first API call; and
using, by the API gateway, the copy of the first token to make the first API call to the first API endpoint.

9. The method of claim 1, wherein the second computing system comprises an API gateway, a token lookup service, and a storage medium accessible to the token lookup service, and the method further comprises:
storing, in the storage medium, first data representing the first token and second data representing the second token;
receiving, by the API gateway and from the client application, a request to make the first API call to the first API endpoint;
in response to the request, retrieving, by the token lookup service, the first data from the storage medium to obtain a copy of the first token that is used to make the first API call to the first API endpoint; and
using, by the API gateway, the copy of the first token to make the first API call to the first API endpoint.

10. The method of claim 9, wherein:
storing the first data and the second data in the storage medium further comprises:
embedding the first data representing the first token and the second data representing the second token into a main token, and
storing a copy of the main token in the storage medium;
retrieving the first data from the storage medium further comprises:
retrieving the copy of the main token from the storage medium on a first occasion, and
extracting the first data representing the first token from the copy of the main token of the first occasion; and
retrieving the second data from the storage medium comprises:
retrieving the copy of the main token from the storage medium on a second occasion, and
extracting the first token from the main token on the second occasion.

11. The method of claim 10, wherein the first computing system further comprises an authorization service configured to generate the main token, and the method further comprises:
sending, from the authorization service to the client application, an opaque token corresponding to the main token;
determining, by the API gateway and based at least in part on receipt of the opaque token from the client application on the first occasion, that the client application has requested that the first API call be made to the first access-restricted resource; and
determining, by the API gateway and based at least in part on receipt of the opaque token from the client application on the second occasion, that the client application has requested that the second API call be made to the second access-restricted resource.

12. The method of claim 9, wherein the first computing system further comprises an authorization service configured to generate the first token and the second token, and the method further comprises:
sending, from the authorization service to the client application, an opaque token corresponding to each of the first token and the second token;
determining, by the API gateway and based at least in part on receipt of the opaque token from the client application on a first occasion, that the client application has requested that the first API call be made to the first access-restricted resource; and
determining, by the API gateway and based at least in part on receipt of the opaque token from the client application on a second occasion, that the client application has requested that the second API call be made to the second access-restricted resource.

13. A system comprising a first computing system, the first computing system including:
at least one first processor; and
at least one first computer-readable medium encoded with instructions which, when executed by the at least one first processor, cause the first computing system to:
receive a first message indicating that a resource owner has authorized a client application to make application programming interface (API) calls to both (A) a first access-restricted resource controlled by the resource owner, and (B) a second access-restricted resource controlled by the resource owner,
in response to the first message, generate both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource, and
send, to a second computing system, the first token and the second token to enable the second computing system to use the first token to make a first API call to the first API endpoint to access the first access-restricted resource, and to use the second token to make a second API call to the second API endpoint to access the second access-restricted resource.

14. The system of claim 13, wherein the at least one first computer-readable medium is further encoded with additional instructions which, when executed by the at least one first processor, further cause the first computing system to:
embed the first token and the second token into a main token; and
send, to the second computing system, the main token.

15. The system of claim 14, further comprising:
at least one second processor; and
at least one second computer-readable medium encoded with instructions which, when executed by the at least one second processor, cause the second computing system to:
receive the main token,
extract first data representing the first token from the main token to obtain a copy of the first token, and
use the copy of the first token to make the first API call to the first API endpoint.

16. The system of claim 15, wherein the at least one first computer-readable medium is further encoded with additional instructions which, when executed by the at least one first processor, further cause the first computing system to:
configure the main token to further enable the second computing system to use the main token to both (A) to authenticate to the first API endpoint to access the first access-restricted resource, and (B) to authenticate to the second API endpoint to access the second access-restricted resource.

17. The system of claim 16, wherein the at least one first computer-readable medium is further encoded with additional instructions which, when executed by the at least one first processor, further cause the first computing system to:
add a first signature to the first token that is based at least in part on content of the first token;
add a second signature to the second token that is based at least in part on content of the second token; and
add a third signature to the main token that is based at least in part on the first signature and the second signature.

18. The system of claim 14, wherein the second computing system includes the client application, and the at least one first computer-readable medium is further encoded with additional instructions which, when executed by the at least one first processor, further cause the first computing system to:
send the main token to the client application.

19. The system of claim 18, wherein the client application is configured to:
receive the main token;
extract first data representing the first token from the main token to obtain a copy of the first token that is used to make the first API call; and
use the copy of the first token to make the first API call to the first API endpoint.

20. At least one non-transitory computer-readable medium encoded with instructions which, when executed by at least one processor of a first computing system, cause the first computing system to:
receive a first message indicating that a resource owner has authorized a client application to make application programming interface (API) calls to both (A) a first access-restricted resource controlled by the resource owner, and (B) a second access-restricted resource controlled by the resource owner;
in response to the first message, generate both (A) a first token that is configured to authenticate to a first API endpoint to access the first access-restricted resource but is not configured to authenticate to a second API endpoint to access the second access-restricted resource, and (B) a second token that is configured to authenticate to the second API endpoint to access the second access-restricted resource but is not configured to authenticate to the first API endpoint to access the first access-restricted resource; and
send, to a second computing system, the first token and the second token to enable the second computing system to use the first token to make a first API call to the first API endpoint to access the first access-restricted resource, and to use the second token to make a second API call to the second API endpoint to access the second access-restricted resource.
